(19) United States
(12) Patent Application Publication
(10) Pub. No.: US 2017/0163103 A1
(43) Pub. Date: Jun. 8, 2017

(54) MAGNET ASSEMBLY

(71) Applicant: WASSIM AMER, Mississauga (CA)

(72) Inventor: WASSIM AMER, Mississauga (CA)

(21) Appl. No.: 14/960,517

(22) Filed: Dec. 7, 2015

(51) Int. Cl. H02K 1/06; F04D 25/06; H02K 1/27; H02K 47/00; H02K 1/17

(52) U.S. Cl. CPC H02K 1/06; H02K 47/00; H02K 1/17; H02K 1/27; F04D 25/06; Y10S 415/916; H02K 53/00

(57) ABSTRACT

A magnet assembly can include a base assembly and a cover assembly. The base assembly can extend along a longitudinal axis and include a base, a shaft, a first cylinder, and a first plurality of magnets. The cover assembly can extend along the longitudinal axis and include a cover, a second cylinder, and a second plurality of magnets. The base assembly and the cover assembly can be selectively engageable. The first plurality of magnets and the second plurality of magnets can be arranged such that the shaft is driven in rotation by magnetic repulsion of the first plurality of magnets relative to the second plurality of magnets when the base assembly and the cover assembly are engaged with one another. The second cylinder can be fixedly engaged with the cover.

### BACKGROUND

1. Field

The present disclosure relates to a generator wherein the force driving the generator shaft in motion is created the repulsion between magnets.

2. Description of Related Prior Art

U.S. Pub. No. 2010/0013335 discloses a PERMANENT MAGNET MOTOR GENERATOR SET. The '335 publication is directed to the method of utilizing unbalanced non-equilibrium magnetic fields to induce a rotational motion in a rotor, the rotor moves with respect to the armature and stator. A three (3) tier device (armature, rotor, and stator) has the armature and stator being fixed in position with the rotor allowed to move freely between the armature and stator. To induce a rotational motion, the rotor, in its concave side uses unbalanced non-equilibrium magnetic fields created by having multiple magnets held in a fixed position by ferritic or like materials to act upon the magnets imbedded in the armature. The rotor, in its convex side has additional unbalanced non-equilibrium magnets and additional pole pair magnets to create a magnetic flux that moves with the moving fixed position fields to cut across closely bonded coils of wire in the stator to induce a voltage and current that is used to generate electrical power. In the practice of the invention multiple permanent magnets of varying strength are geometrically positioned in multiple groups to produce a motive power in a single direction with the remainder of the unbalanced magnetic flux positioned and being used to cut across the coils of wire to produce continuous electric power. In the practice of the invention the permanent magnet motor-generator set produces no pollutants nor does it create any greenhouse emissions during operation.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A magnet assembly can include a base assembly and a cover assembly. The base assembly can extend along a longitudinal axis and include a base, a shaft, a first cylinder, and a first plurality of magnets. The shaft can extend from the base along the longitudinal axis and be rotatable relative to the base. The first cylinder can be fixed with the shaft for concurrent rotation and have a first inner surface confronting the shaft and a first outer surface radially spaced from the first inner surface. The first plurality of magnets can each be disposed on the first cylinder proximate to the first outer surface and have a first pole axis spaced from the longitudinal axis. The cover assembly can extend along the longitudinal axis and include a cover, a second cylinder, and a second plurality of magnets. The second cylinder can be engaged with the cover and have a second inner surface confronting the first outer surface and a second outer surface radially spaced from the second inner surface. The second plurality of magnets can each be disposed on the second cylinder proximate to the second inner surface and have a second pole axis spaced from the longitudinal axis. The base assembly and the cover assembly can be selectively engageable with one another. The first plurality of magnets and the second plurality of magnets can be arranged such that the shaft is driven in rotation by magnetic repulsion of the first plurality of magnets relative to the second plurality of magnets when the base assembly and the cover assembly are engaged with one another. The second cylinder can be fixedly engaged with the cover.

### BRIEF DESCRIPTION OF THE DRAWINGS

The detailed description set forth below references the following drawings:

FIG. 1 is a perspective view of a magnet assembly according to an exemplary embodiment of the present disclosure;

FIG. 2 is an exploded view of the magnet assembly shown in FIG. 1;

FIG. 3 is an exploded view of the magnet assembly shown in FIGS. 1 and 2 with portions cut-away to reveal internal structures;

FIG. 4 is an exploded view of the magnet assembly shown in FIGS. 1-3 with portions cut-away to reveal internal structures;

FIG. 5 is a cross-section through section lines 5-5 in FIG. 1;

FIG. 6 is a detail view taken from detail circle 6 in FIG. 5;

FIG. 7 is a cross-section through section lines 7-7 in FIG. 1;

FIG. 8 is a cross-section similar to the cross-section of FIG. 7 but of an alternative embodiment of the present disclosure;

FIG. 9 is a schematic view of an alternative embodiment of the present disclosure;

FIG. 10 is a schematic view of an alternative embodiment of the present disclosure; and

FIG. 11 is a schematic of another exemplary embodiment of the present disclosure.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

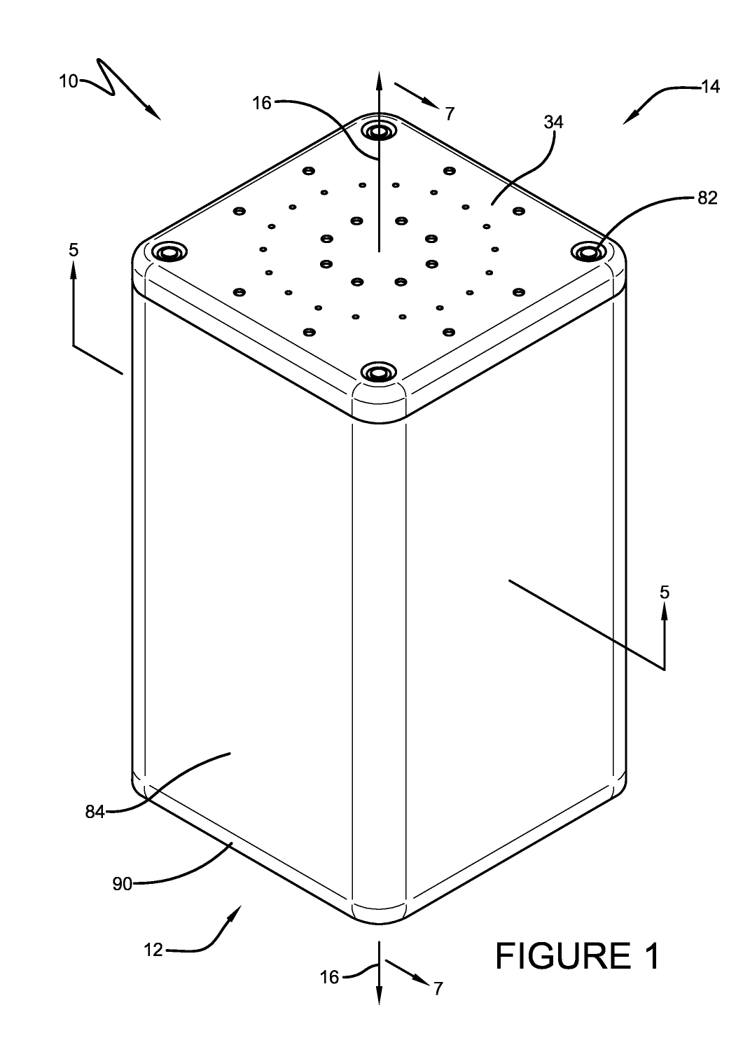

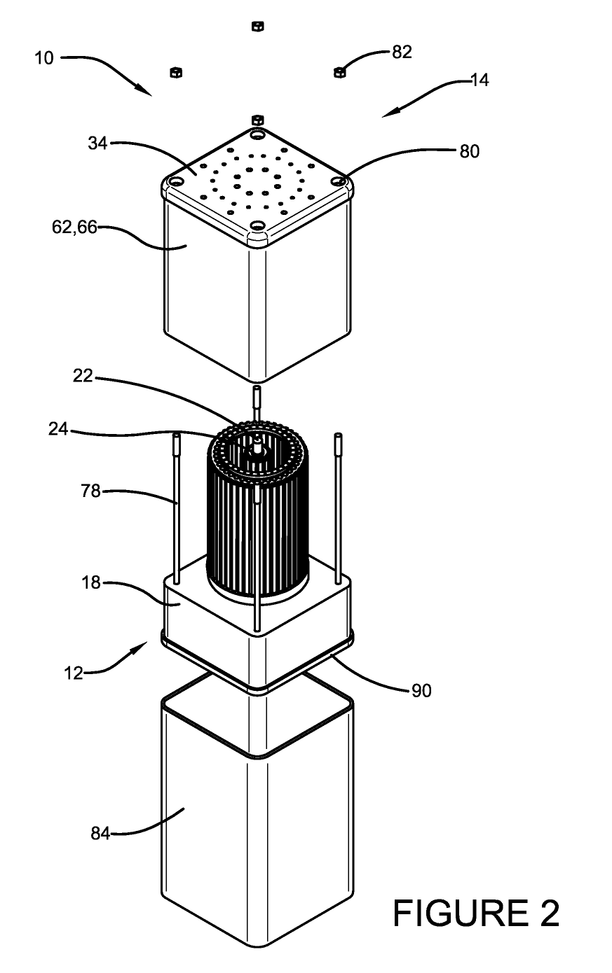

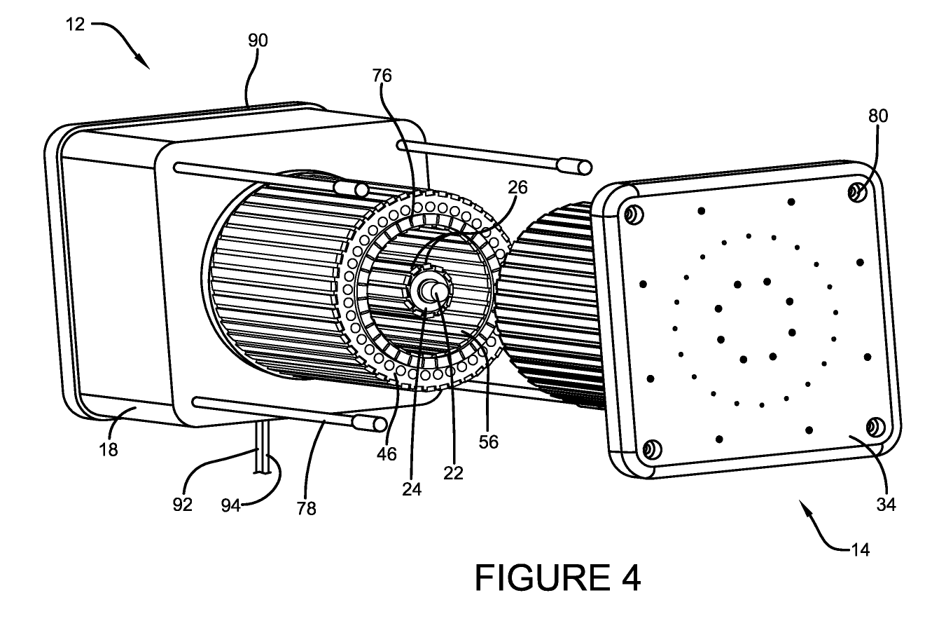

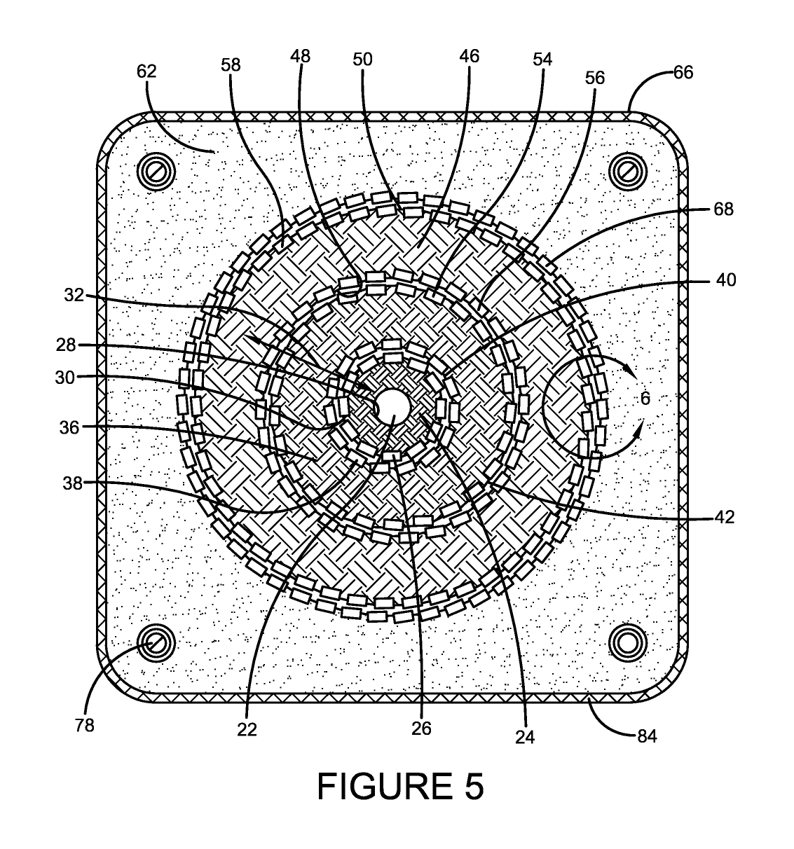

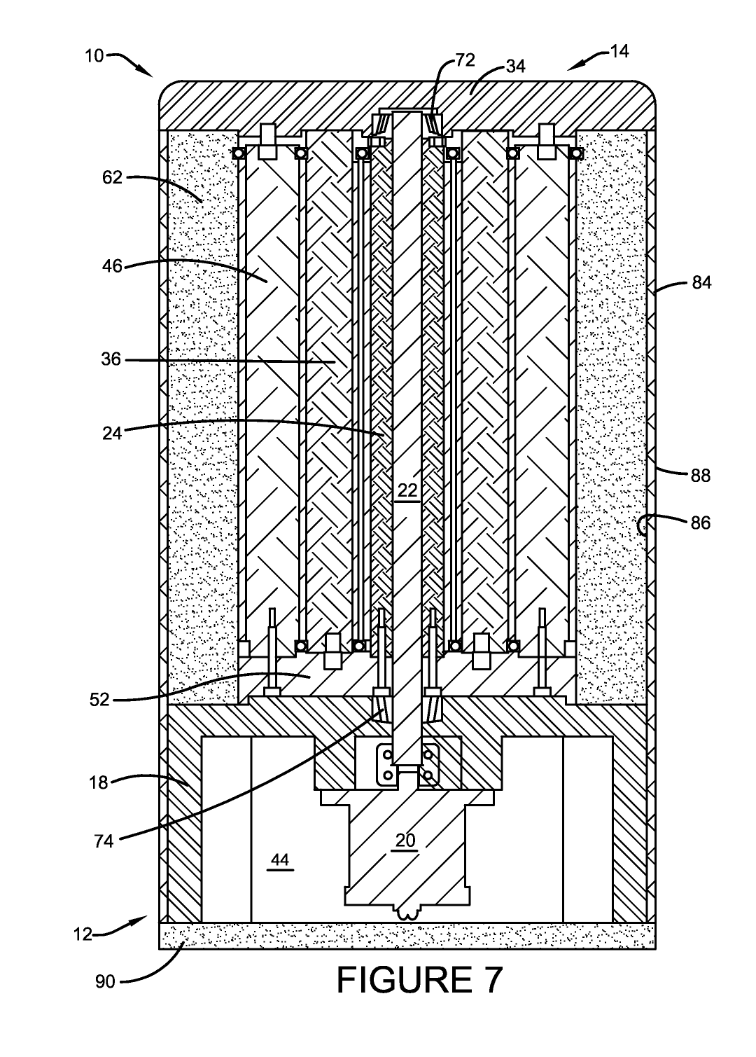

Referring now to FIGS. 1 and 2, a magnet assembly 10 can include a base assembly 12 and a cover assembly 14. The base assembly 12 can extend along a longitudinal axis 16 and include a base 18, a generator 20 (referenced in FIG. 7), a shaft 22, a first cylinder 24, and a first plurality of magnets, such as the magnets referenced at 26 in FIGS. 4 and 5. The generator 20 can be mounted to the base 18. The shaft 22 can extend from the generator 20 along the longitudinal axis 16 and be rotatable relative to the base 18, The first cylinder 24 can be fixed with the shaft 22 for concurrent rotation and have a first inner surface 28 confronting the shaft 22 and a first outer surface 30 radially spaced from the first inner surface 28 (both surfaces 28, 30 referenced in FIG. 5). The first plurality of magnets 26 can each be disposed on the first cylinder 24 proximate to the first outer surface 30 and have a first pole axis spaced from the longitudinal axis 16. An exemplary first pole axis is referenced at 32 in FIG. 5. The pole axis 32 does not intersect longitudinal axis 16 and is thus spaced from the longitudinal axis 16.

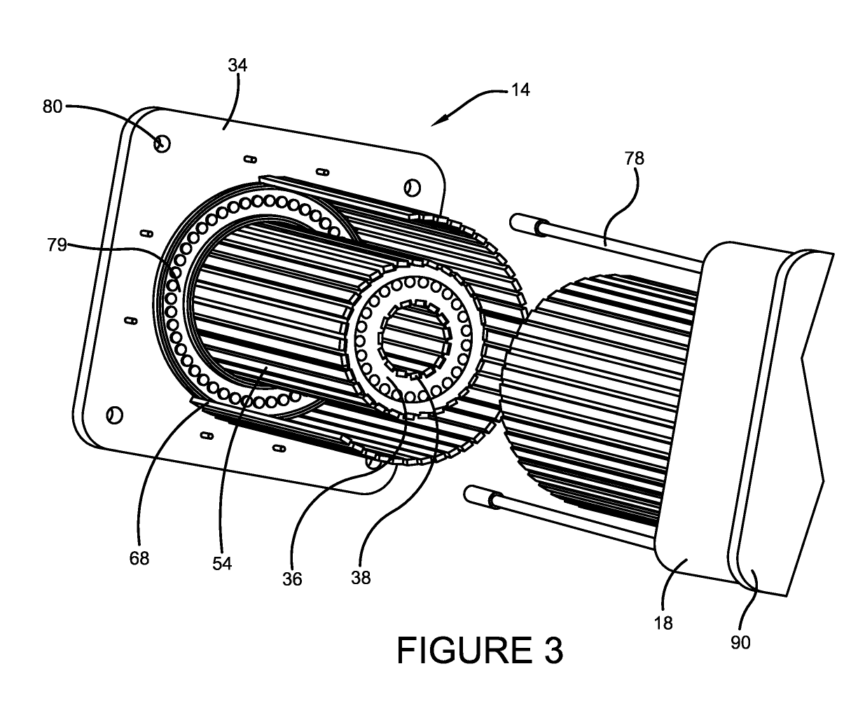

The cover assembly 14 can extend along the longitudinal axis 16 and include a cover 34, a second cylinder 36, and a second plurality of magnets, such as the magnets referenced at 38 in FIGS. 3 and 5. The second cylinder 36 can be engaged with the cover 34 and have a second inner surface 40 confronting the first outer surface 30 and a second outer surface 42 radially spaced from the second inner surface 40. The second plurality of magnets 38 can each be disposed on the second cylinder 36 proximate to the second inner surface 40 and have a second pole axis spaced from the longitudinal axis 16. The base assembly 12 and the cover assembly 14 can be selectively engageable with one another. The second cylinder 36 can be fixedly engaged with the cover 34.

The first plurality of magnets 26 and the second plurality of magnets 38 can be arranged such that the shaft 22 is driven in rotation by magnetic repulsion of the first plurality of magnets 26 relative to the second plurality of magnets 38 when the base assembly 12 and the cover assembly 14 are engaged with one another. The north poles of each of the magnets 26 can confront the north poles of each of the magnets 38. This assembly depends on the repulsion between similar poles of magnets regardless which pole. In this document, we have selected the north pole as an example. Since the pole axes are spaced from the longitudinal axis 16, the confrontation of the magnets 26, 38 can repulse one another and thereby urge the first cylinder 24 and shaft 22 in rotation. Rotation of the shaft 22 can cause the generator 20 to generate electrical current.

It is noted that one or more embodiments of the present disclosure can include brake to lock the shaft 22 and inhibit the exhaustion of the working lives of the components of the magnet assembly 10. Alternatively, the cover assembly 14 can be removed from the base assembly 12 to inhibit the exhaustion of the working lives of the components of the magnet assembly 10. Alternatively, the shaft 22 and the generator 20 can be coupled with a clutch to inhibit the exhaustion of the working lives of at least some of the components of the magnet assembly 10.

The shaft 22 can rest on the base 18 during rotation. As best shown in FIG. 7, the generator 20 and the cylinder 24 can be disposed on opposite sides of base 18. The generator 20 can be disposed in a pocket 44 defined on three sides by the base 18.

As best shown in FIGS. 4, 5 and 7, the magnet assembly 10 can also include a third cylinder 46. The third cylinder 46 can include a third inner surface 48 confronting the second cylinder 36 and a third outer surface 50 radially spaced from the third inner surface 48. The magnet assembly 10 can also include a plate 52 interconnecting the third cylinder 46 with the shaft 22 for concurrent rotation.

A third plurality of magnets can be disposed on the second cylinder 36 proximate to the second outer surface 42, such as the magnets referenced at 54 in FIGS. 3 and 5. Each of the magnets 54 can have a third pole axis spaced from the longitudinal axis 16. A fourth. plurality of magnets can be individually disposed on the third cylinder 46 proximate to the third inner surface 48, such as the magnets referenced at 56 in FIGS. 4 and 5. Each of the magnets 56 can have a fourth pole axis spaced from the longitudinal axis 16. The third plurality of magnets 54 and the fourth plurality of magnets 56 can be arranged such that the shaft 22 is driven in rotation by magnetic repulsion of the third plurality of magnets 54 relative to the fourth plurality of magnets 56 when the base assembly 12 and the cover assembly 14 are engaged with one another. The cooperative interaction of the magnets 54, 56 can be consistent with the cooperative interaction of the magnets 26, 38 such that the magnets 26, 38, 54, 56 drive the shaft 22 in the same direction of rotation.

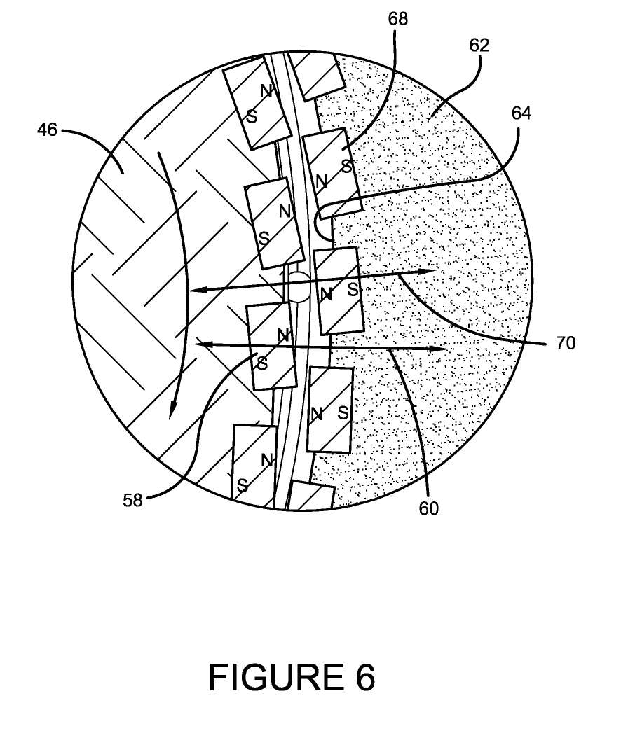

A fifth plurality of magnets each disposed on the third cylinder 46 proximate to the third outer surface 50, such as the magnets referenced at 58 in FIGS. 4 and 5. Each of the fifth plurality of magnets 58 can include a fifth pole axis spaced from the longitudinal axis 16. An exemplary fifth pole axis is referenced at 60 in FIG. 6.

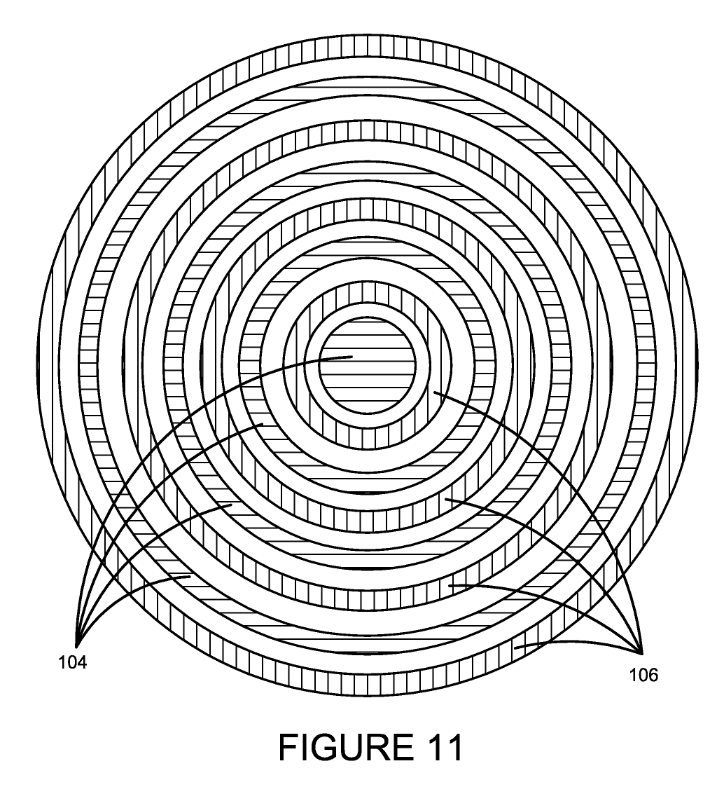

It is noted that one or more alternative embodiments of the present disclosure can include more than three cylinders. Such a combination of cylinders can include a combination of fixed cylinders in the middle and combinations of rotating cylinders on the inner and outer sides. FIG. 11 is a schematic of another exemplary embodiment of the present disclosure. In FIG. 11, the structures referenced at 104 are disposed for rotation and the structures referenced at 106 are fixed. Magnets can be positioned on the radially-outer and radially-inner surfaces of the structures 104 and 106 (except the center structure which will only have magnets on the radially-outer surface) to induce rotation of the structures 104. This arrangement can be repeated in a pattern of fixed and rotating combination of cylinders in order to increase the torque on the shaft.

The magnet assembly 10 can also include an outer member 62 fixedly engaged with the cover 34. The outer member 62 can include a fourth inner surface 64 confronting the third cylinder 46 and a fourth outer surface 66 radially spaced from the fourth inner surface 64. The exemplary fourth outer surface 66 can be polygonal. The cover 34, the outer member 62, and a shield 84 (described in greater detail below) can include one or more vents to allow air to pass into and out of the assembly 10 to expel heat.

A sixth plurality of magnets each disposed on the outer member 62 proximate to the fourth inner surface 64, such as the magnets referenced at 68 in FIGS. 3, 5 and 6. Each of the sixth plurality of magnets 68 can include a sixth pole axis spaced from the longitudinal axis 16. An exemplary sixth pole axis is referenced at 70 in FIG. 6.

The fifth plurality of magnets 58 and the sixth plurality of magnets 68 are arranged such that the shaft 22 is driven in rotation by magnetic repulsion of the fifth plurality of magnets 58 relative to the sixth plurality of magnets 68 when the base assembly 12 and the cover assembly 14 are engaged with one another. The cooperative interaction of the magnets 58, 68 can be consistent with the cooperative interaction of the magnets 26, 38, 54, 56 such that the magnets 26, 38, 54, 56, 58, 68 drive the shaft 22 in the same direction of rotation.

A plurality of bearings can support the shaft 22 and the third cylinder 46 for rotation. Thrust bearings can be disposed on opposite ends of the shaft 22. A first thrust bearing 72 can be positioned in the cover 34. A second thrust bearing 74 can be positioned in the base 18. Bearings can be positioned between the plate 52 and the base 18. A plurality of bearings 76 can be positioned between the third cylinder 46 and the cover 34. A race 79 of the bearings 76 can be defined by the cover 34.

The magnet assembly 10 can also include a plurality of posts and a plurality of apertures. The plurality of posts, such as post 78, can each extend from the base 18 parallel to the shaft 22. The plurality of apertures, such as aperture 80, can be defined in the cover 34. Each of the plurality of posts can be received in one of the plurality of apertures when the base assembly 12 and the cover assembly 14 are engaged with one another. The distal ends of the posts can be threaded to receive fasteners, such as nuts 82 shown in FIGS. 1 and 2. The plurality of posts can extend through the outer member 62

The magnet assembly 10 can also include the shield 84. The shield 84 can include a fifth inner surface 86 confronting the base 18 and the outer member 62 and a fifth outer surface 88 radially spaced from the fifth inner surface 86. The magnet assembly 10 can also include a cap 90 engaged with the base 18. The cap 90 can cooperate with the base 18 to define the enclosed pocket 44. The generator 20 can be disposed in the pocket 44. The shield 84 can extend between the cap 90 and the cover 34. The fourth outer surface 66 of the outer member 62 and the fifth inner surface 86 of the shield 84 can be sized and shaped to engage in telescopic sliding engagement. These surfaces 66, 86 can slide against one another and cooperatively guide the cover assembly 14 during assembly to the base assembly 12.

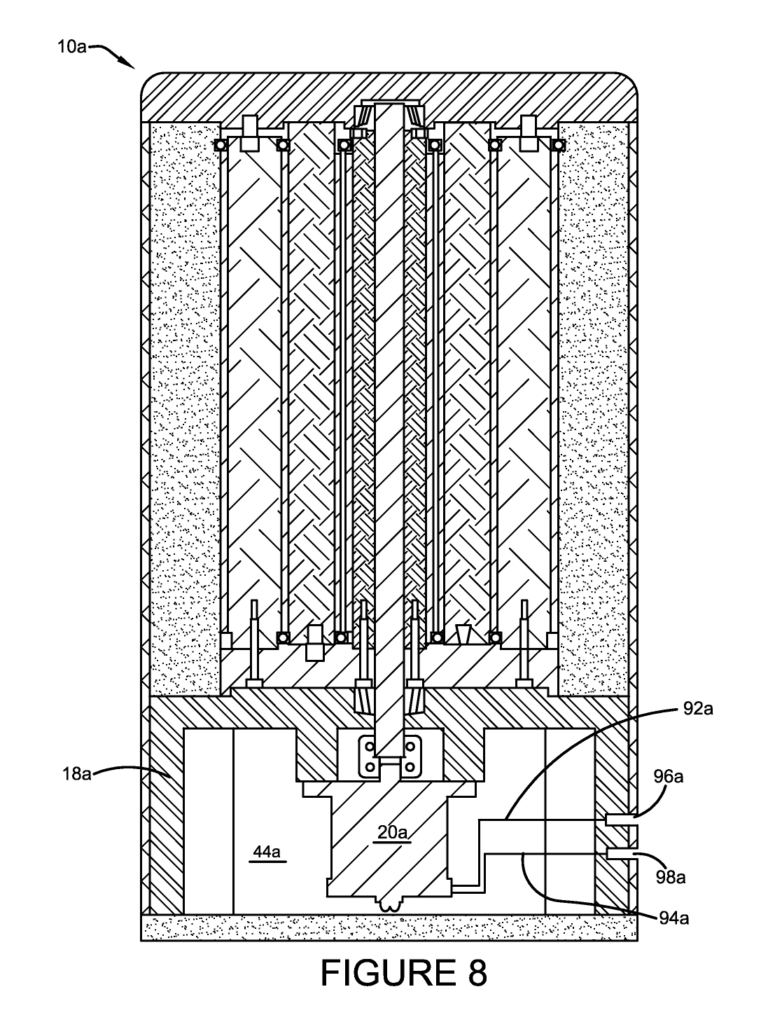

FIG. 8 illustrates an alternative embodiment of the present disclosure. A magnet assembly 10a can include a generator 20a mounted in a pocket 44a of a base 18a. A positive lead 92a and a negative lead 94a can extend from the generator 20a. Positive and negative leads 92, 94 are also shown in FIG. 4. The positive lead 92a can extend to a positive terminal 96a mounted on the base 18. The negative lead 94a can extend to a negative terminal 98a mounted on the base 18. The terminals 96a, 98a can take any desired form. The terminals 96a, 98a can take the form of an electrical outlet, The terminals 96a, 98a can take the form of male connectors or female connectors.

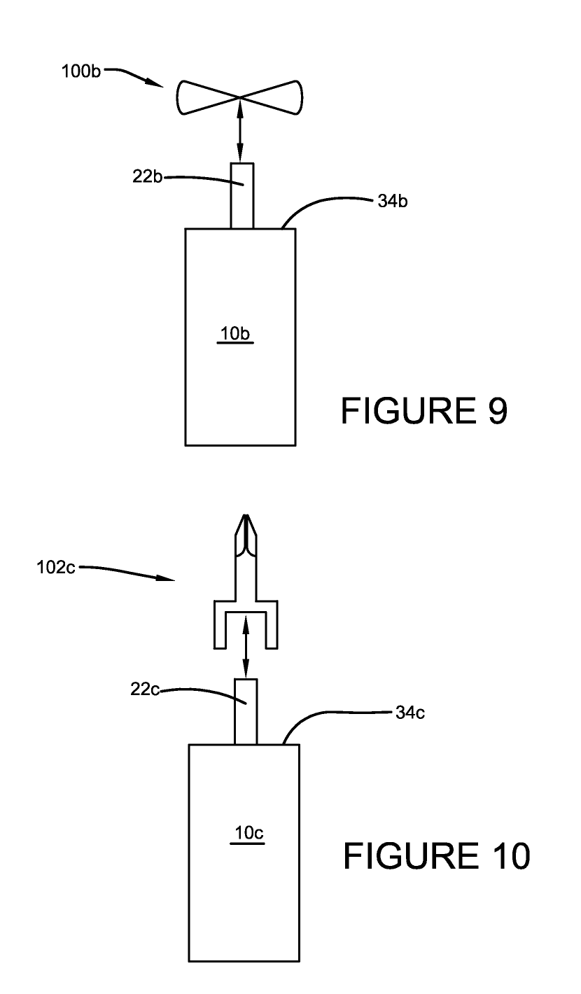

FIG. 9 illustrates an alternative embodiment of the present disclosure. A magnet assembly 10b can include internal components similar to the magnet assembly 10. A shaft 22b can extend out of a cover 34b of the magnet assembly 10b. A fan 100b can be mounted on the shaft 22b. The fan 100b can be driven in rotation by the shaft 22b, which can be driven in rotation by the internal components similar to the magnet assembly 10b.

FIG. 10 illustrates an alternative embodiment of the present disclosure. A magnet assembly 10c can include magnet assembly 10. A shaft 22c can extend out of a cover 34c of the magnet assembly 10c. A drill bit 102c can be mounted on the shaft 22c. The drill bit 102c can be driven in rotation by the shaft 22c, which can be driven in rotation by the internal components similar to the magnet assembly 10c.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. Further, the “present disclosure” as that term is used in this document is what is claimed in the claims of this document. The right to claim elements and/or sub-combinations that are disclosed herein as other present disclosures in other patent documents is hereby unconditionally reserved.

What is claimed is:

1. A magnet assembly comprising:
a base assembly extending along a longitudinal axis and having:
a base,
a shaft extending from said base along said longitudinal axis and rotatable relative to said base,
a first cylinder fixed with said shaft for concurrent rotation and having a first inner surface confronting said shaft and a first outer surface radially spaced from said first inner surface, and
a first plurality of magnets each disposed on said first cylinder proximate to said first outer surface and having a first pole axis spaced from said longitudinal axis;
a cover assembly extending along said longitudinal axis and having:
a cover,
a second cylinder engaged with said cover and having a second inner surface confronting said first outer surface and a second outer surface radially spaced from said second inner surface,
a second plurality of magnets each disposed on said second cylinder proximate to said second inner surface and having a second pole axis spaced from said longitudinal axis;
wherein said base assembly and said cover assembly are selectively engageable with one another;
wherein said first plurality of magnets and said second plurality of magnets arc arranged such that said shaft is driven in rotation by magnetic repulsion of said first plurality of magnets relative to said second plurality of magnets when said base assembly and said cover assembly are engaged with one another; and
wherein said second cylinder is fixedly engaged with said cover.

2. The magnet assembly of claim 1 further comprising:
a generator mounted to said base wherein said shaft extends from said generator, said generator operable to generate electrical current when said shaft rotates.

3. The magnet assembly of claim 2 wherein said shaft rests on said base during rotation.

4. The magnet assembly of claim 3 wherein said generator and said cylinder are on opposite sides of base.

5. The magnet assembly of claim 4 wherein said generator is disposed in a pocket defined on three sides by said base.

6. The magnet assembly of claim 1 further comprising:
a third cylinder having a third inner surface confronting said second cylinder and a third outer surface radially spaced from said third inner surface.

7. The magnet assembly of claim 6 further comprising:
a plate interconnecting said third cylinder with said shaft for concurrent rotation.

8. The magnet assembly of claim 7 further comprising:
a third plurality of magnets each disposed on said second cylinder proximate to said second outer surface and having a third pole axis spaced from said longitudinal axis.

9. The magnet assembly of claim 8 further comprising:
a fourth plurality of magnets each disposed on said third cylinder proximate to said third inner surface and having a fourth pole axis spaced from said longitudinal axis, wherein said third plurality of magnets and said fourth plurality of magnets are arranged such that said shaft is driven in rotation by magnetic repulsion of said third plurality of magnets relative to said fourth plurality of magnets when said base assembly and said cover assembly are engaged with one another.

10. The magnet assembly of claim 9 further comprising:
a fifth plurality of magnets each disposed on said third cylinder proximate to said third outer surface and having a fifth pole axis spaced from said longitudinal axis.

11. The magnet assembly of claim 10 further comprising:
an outer member fixedly engaged with said cover and having a fourth inner surface confronting said third cylinder and a fourth. outer surface radially spaced from said fourth inner surface.

12. The magnet assembly of claim 11 wherein said fourth outer surface is polygonal,

13. The magnet assembly of claim 11 further comprising:
a sixth plurality of magnets each disposed on said outer member proximate to said fourth inner surface and having a sixth pole axis spaced from said longitudinal axis, wherein said fifth plurality of magnets and said sixth plurality of magnets are arranged such that said shaft is driven in rotation by magnetic repulsion of said fifth plurality of magnets relative to said sixth plurality of magnets when said base assembly and said cover assembly are engaged with one another.

14. The magnet assembly of claim 11 further comprising:
a plurality of bearings positioned between said third cylinder and said cover.

15. The magnet assembly of claim 1 further comprising:
a positive terminal mounted on said base; and
a negative terminal mounted on said base.

16. The magnet assembly of claim 1 further comprising:
a plurality of posts each extending from said base parallel to said shaft; and
a plurality of apertures defined in said cover wherein said plurality of posts are received in said plurality of apertures.

17. The magnet assembly of claim 16 further comprising:
an outer member fixedly engaged with said cover and having a fourth inner surface directed toward said longitudinal axis and a fourth outer surface radially spaced from said fourth inner surface, wherein said plurality of posts extend through said outer member.

18. The magnet assembly of claim 17 further comprising:
a shield having a fifth inner surface confronting said base and said outer member and a fifth outer surface radially spaced from said fifth inner surface.

19. The magnet assembly of claim 1 further comprising:
a fan mounted on said shaft.

20. The magnet assembly of claim 1 further comprising:
a drill bit mounted on said shaft.
